(19) United States
(12) Patent Application Publication
(10) Pub. No.: US 2018/0352860 A1
(43) Pub. Date: Dec. 13, 2018

(54) ATOMIZER, ELECTRONIC CIGARETTE, AND CONTROL METHOD FOR ELECTRONIC CIGARETTE

(71) Applicant: Changzhou Patent Electronic Technology Co.,ltd, Changzhou (CN)

(72) Inventor: WEI-HUA QIU, ChangZhou (CN)

(21) Appl. No.: 15/993,577

(22) Filed: May 30, 2018

(30) Foreign Application Priority Data
Jun. 7, 2017 (CN) 201720658314.X

(51) Int. Cl. A24F 47/00; H05B 3/48; G05B 13/02

(52) U.S. Cl. CPC A24F 47/008; G05B 13/024; H05B 3/48

(57) ABSTRACT

An atomizer for an electronic cigarette with two heating elements which can be independently controlled includes an outer tube, a ventilation assembly, and a smoke pan. The ventilation assembly with an air inlet channel is separate from the smoke pan. The ventilation assembly includes a first heating member configured to heat incoming air in the channel, and the smoke pan includes a second heating member able to heat the smoke pan containing smokable material. An atomizing cavity communicating with the air inlet channel is defined in the smoke pan. An electronic cigarette having the atomizer and a method for the working processes thereof are also disclosed.

### FIELD

The present disclosure relates to smoking simulator, and more particularly to an atomizer, an electronic cigarette, and a control method for the electronic cigarette.

### BACKGROUND

A conventional electronic cigarette can only heat smoking materials in a smoke pan, such as tobacco, tobacco pieces, or tobacco paste, but the gas that is about to enter the smoke pan cannot be heated by the conventional electronic cigarette. The temperature of the outside air is lower than the temperature inside the smoke pan. The outside air entering into the smoke pan through the air inlet channel will reduce the temperature of the smoking materials, which can cause heat loss from the smoking materials and reduce the amount of generated smoke. Therefore, the taste of the smoke is affected and the user's experience is reduced.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a cross-sectional view of an atomizer.

FIG. 2 is an exploded view of the atomizer shown in FIG. 1.

FIG. 3 is a block diagram of the atomizer shown in FIG. 1.

FIG. 4 is a flowchart of a method for working processes of the atomizer shown in FIG. 1.

FIG. 5 is a flowchart of a method for control process of the atomizer shown in FIG. 5.

### DETAILED DESCRIPTION

To make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

It should be noted that, when an element is considered to be “fixed to” another element, which can be either directly fixed on another element or indirectly fixed on another element with a centered element. When an element is considered to be “coupled with” another element, which can be either directly coupled with another element or indirectly coupled with another element with a centered element at the same time.

Unless otherwise defined, all technical and scientific terms used herein have the same meaning as commonly understood by one skilled in the art. The terms used in a specification of the present application herein are only for describing specific embodiments, and are not intended to limit the utility. The terms “and/or” used herein includes any and all combinations of one or more of associated listed items.

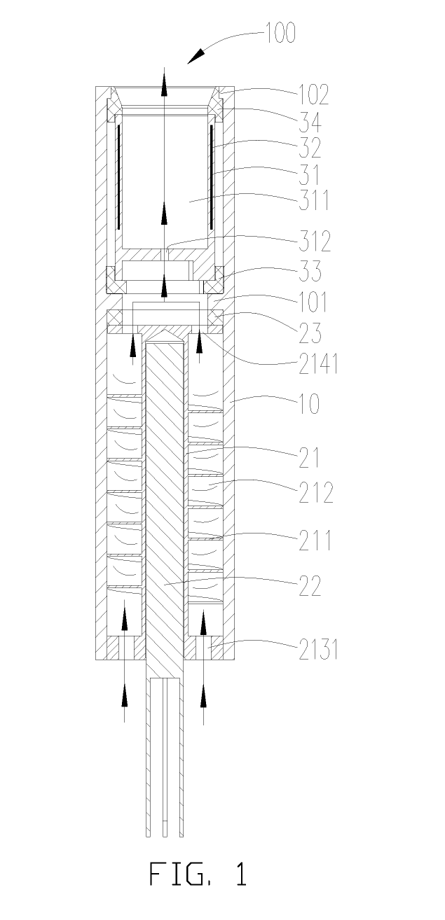

Referring to FIG. 1-3, the present disclosure provides an electronic cigarette. The electronic cigarette includes an atomizer 100 and a power supply device 200. The power supply device 200 connects to the atomizer 100, and provides power for the atomizer 100. The atomizer 100 includes an outer tube 10, a ventilation assembly 20, and a smoke pan assembly 30. The ventilation assembly 20 and the smoke pan assembly 30 are received in the outer tube 10. The ventilation assembly 20 is spaced from the smoke pan assembly 30, and the ventilation assembly 20 and the smoke pan assembly 30 are disposed along the axial direction of the outer tube 10. When using the electronic cigarette, external air enters the smoke pan assembly 30 via the ventilation assembly 20, and brings out smoke generated in the smoke pan assembly 30 for a user.

Specifically, the outer tube 10 is substantially a hollow tubular structure with openings at both ends. A part of the inner circumferential surface of the outer tube 10 is extended inwardly along the radial direction to form a first supporting rim 101. The ventilation assembly 20 is inserted in the outer tube 10 from the lower end of the outer tube 10, and the upper end of the ventilation assembly 20 abuts against the first supporting rim 101. The smoke pan assembly 30 is inserted in the outer tube 10 from the upper end of the outer tube 10, and the lower end of the smoke pan assembly 30 abuts against the first supporting rim 101. The smoke pan assembly 30 is isolated from the ventilation assembly 20 by the first supporting rim 101, to block heat that would otherwise be conducted between the smoke pan assembly 30 and the ventilation assembly 20. Such unwanted heat would affect temperatures of the smoke pan assembly 30 and ventilation assembly 20. This particularly meets the needs of users who desire the temperatures of the smoke pan assembly 30 and the ventilation assembly 20 to be different.

In the illustrated embodiment, the upper end of the outer tube 10 is bent inwardly along the radial direction of the outer tube 10 to form a second supporting rim 102.

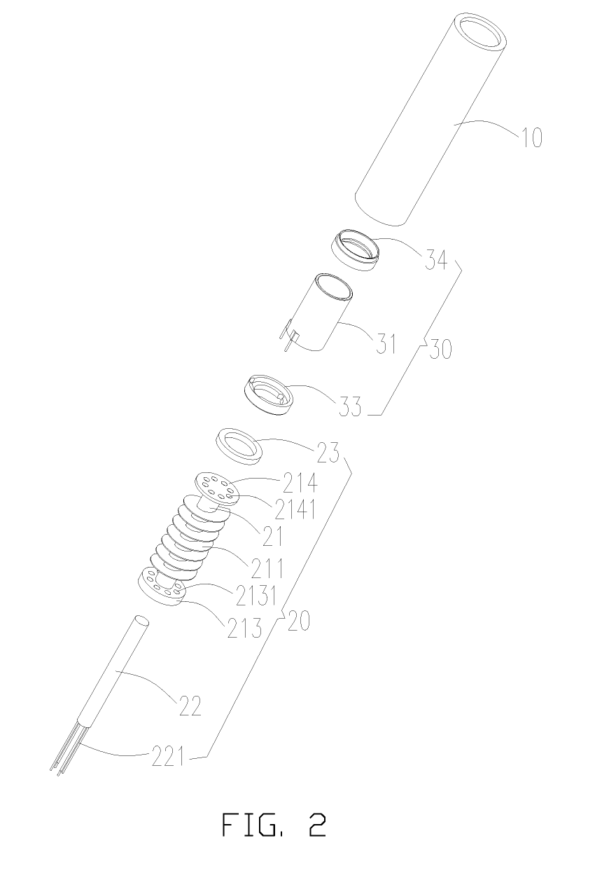

Referring to FIG. 2, the ventilation assembly 20 includes a ventilation member 21 received in the outer tube 10, and a first heating member 22 configured to heat the ventilation member 21.

Referring to FIG. 1, the ventilation member 21 is substantially a hollow tubular structure with an opening at an end. The ventilation member 21 is tightly sleeved at the outside of the first heating member 22, and another end of the ventilation member 21 abuts against the first supporting rim 101 of the outer tube 10. A spiral slice 211 is formed on the outer circumferential surface of the ventilation member 21. A side of the spiral slice 211 is fixedly connected with the outer circumferential surface of the ventilation member 21, and another side of the spiral slice 211 abuts against the inner circumferential surface of the outer tube 10. The space between the spiral slice 211, the outer circumferential surface of the ventilation member, and the inner circumferential surface of the outer tube forms a helical air inlet channel 212.

In other embodiments, the spiral slice 211 is formed on the inner circumferential surface of the outer tube 10. A side of the spiral slice 211 is fixedly connected with the inner circumferential surface of the outer tube 10, and another side of the spiral slice 211 abuts against the outer circumferential surface of the ventilation member 21. The space between the spiral slice 211, the outer circumferential surface of the ventilation member, and the inner circumferential surface of the outer tube forms the helical air inlet channel 212.

In another embodiment, the ventilation member 21 is porous. The ventilation member 21 sleeves on the outside of the first heating member 22, and the outer circumferential surface of the ventilation member 21 abuts against the inner circumferential surface of the outer tube 10. Pores in the ventilation member 21 communicate to form the air inlet channel 212. The pores in the ventilation member 21 increase the specific surface area, increasing the heating area of an air flow flowing through the ventilation member 21. Additionally, since the pores in the ventilation member 21 are connected in a meandering manner, the flow path of the air flow is lengthened. Therefore, the heating time of the air flow is increased.

Referring to FIG. 2, an end of the ventilation member 21 away from the first supporting rim 101 is extended along the radial direction of the ventilation member 21 to form a first flange 213. Another end of the ventilation member 21 opposite to the first flange 213 is extended along the radial direction of the ventilation member 21 to form a second flange 214. When the ventilation member 21 is assembled in the outer tube 10, outer circumferential surfaces of the first flange 213 and the second flange 214 abut against the inner circumferential surface of the outer tube 10, and the upper surface of the first flange 213 abuts against the first supporting rim 101. In the illustrated embodiment, the first flange 213 is held in the outer tube 10 by an interference fit created between the outer circumferential surface of the first flange 213 and the inner circumferential surface of the outer tube 10. In another embodiment, the first flange 213 can be coupled to the outer tube 10 by way of threaded connection, latched connection, or plugged connection, the manner of connection between the first flange 213 and the outer tube 10 is not limited hereto.

To improve sealing between the second flange 214 and the outer tube 10, the ventilation assembly 20 further includes a first sealing member 23 sandwiched between the second flange 214 and the first supporting rim 101. The first sealing member 23 can be made of rubber or silicone.

To facilitate entry of external air to the electronic cigarette, at least one first air inlet 2131 is defined on the first flange 213 around the axis of the ventilation member 21. Each first air inlet 2131 communicates with the air inlet channel 212. To facilitate entry of heated air to the smoke pan assembly 30, at least one second air inlet 2141 is defined on the second flange 214 around the axis of the ventilation member 21. Each second air inlet 2141 communicates with the air inlet channel 212. In another embodiment, the first air inlet 2131 can be defined at the lower portion of the sidewall of the outer tube 10, or be defined on the first flange 213 and the outer tube 10, as long as the first air inlets 2131 can communicate with the air inlet channel 212.

The first heating member 22 is electrically connected with the power supply device 200. The power supply device 200 electrically heats the first heating member 22. In the illustrated embodiment, the first heating member 22 is sleeved in the ventilation member 21. In another embodiment, the first heating member can be sleeved on the outside of the ventilation member 21, or positioned in the wall of the ventilation member 21. In the illustrated embodiment, the first heating member 22 is a metal heating rod. The lower end of the first heating member 22 extends downwardly to form a pair of pin-outs 221 electrically connecting with the power supply device 200. In another embodiment, the first heating member 22 can be substantially a rod-like structure such as a ceramic heating rod. Alternatively, the first heating member 22 can be a helical heating coil, positioned around the exterior of the ventilation member 21. Each round of the helical heating coil is positioned in a space of the spiral slice 211. In another embodiment, the first heating member 22 comprises heating wires sintered in the wall of the ventilation member 21.

If the first heating member 22 is substantially a rod-like structure in an embodiment, the ventilation member 21 can be omitted. The air inlet channel 212 is formed by a space between the outer circumferential surface of the first heating member 22 and the inner circumferential surface of the outer tube 10.

Referring to FIG. 1, the smoke pan assembly 30 includes a smoke pan 31 received in the outer tube 10, and a second heating member 32 configured to heat the smoke pan 31.

The smoke pan 31 is substantially a hollow tubular structure with an opening at the upper end. The lower end of the smoke pan 31 abuts against the first supporting rim 101, and the upper end of the smoke pan 31 abuts against the second supporting rim 102, so that the smoke pan 31 is fixed in the outer tube 10. An inner cavity of the smoke pan 31 forms an atomizing cavity 311 configured to hold smoking materials. At least one ventilation hole 312 is defined at the bottom of the smoke pan 31. The ventilation hole 312 communicates with the second air inlet 2141 and the atomizing cavity 311.

The second heating member 32 is electrically connected with the power supply device 200. In the illustrated embodiment, the smoke pan 31 is made of ceramic materials. The second heating member 32 comprises heating wires sintered in the wall of the smoke pan 31. In another embodiment, the smoke pan 31 can be made of metal materials. Additionally, the second heating member 32 can be positioned at the outer or inner circumferential surface of the smoke pan 31, or positioned in the inner cavity of the smoke pan 31, as long as the second heating member 32 is able to heat smoking materials through the smoke pan 31, or heat smoking materials directly. When the smoke pan 31 is made of metal materials, to insulate the smoke pan 31 and the second heating member 32, an insulating layer can be provided where the smoke pan 31 and the second heating member 32 are in contact, and/or provided on the outer circumferential surface of the second heating member 32.

When a user inhales smoke, external air enters the air inlet channel 212 through the first air inlet 2131, and then reaches the atomizing cavity 311 via the second air inlet 2141 and the ventilation hole 312 in that order. The arrows shown in FIG. 1 indicates a flow direction of air flow. External air brings with it the smoke generated by smoking materials for the user to inhale. In other embodiment, the external air can be scented or scented gas and air mixture, which is not harmful for user. When the external air includes scented gas, the taste of the smoke and the user's experience are improved.

When using the electronic cigarette, the second heating member 32 is electrically heated by the power supply device 200. The heat is transferred to the smoke pan 31 to heat smoking materials, so that smoke is generated. The smoke is inhaled by the user. The first heating member 22 is electrically heated by the power supply device 200. The heat is transferred to the ventilation member 21, and further to the spiral slice 211 by the ventilation member 21. Being parts of the air inlet channel 212, both the spiral slice 211 and the outer circumferential surface of the ventilation member 21 heat the external air flowing through the air inlet channel 212. Since the air inlet channel 212 is a helical channel, the distance of flow of the external air in the air inlet channel 212 is increased, the heating time of the external air flowing through the air inlet channel 212 is prolonged, and the contact area between the external air and the spiral slice 211 is increased. Accordingly, the external air can be heated to a higher temperature. When the external air arrives at the atomizing cavity 311, a temperature of the external gas is almost the same as a temperature of the atomizing cavity 311. Therefore, heat loss of the smoking materials is reduced, the smoking materials generate more smoke, and taste of smoke is improved.

Referring to FIG. 1, to improve sealing of the electronic cigarette, the smoke pan assembly 30 further includes a second sealing member 33 sandwiched between the lower end of the smoke pan 31 and the first supporting rim 101. A third sealing member 34 is sandwiched between the upper end of the smoke pan 31 and the second supporting rim 102. Therefore, gas flowing out through the air inlet channel 212 is only able to enter the atomizing cavity 311 through the ventilation hole 312. The utilization ratio of the gas in the air inlet channel 212 is increased. Additionally, the second sealing member 33 and the third sealing member 34 create a gap or break between the outer tube 10 and the smoke pan 31. With such gap, the heat conduction between the outer tube 10 and the smoke pan 31 is greatly reduced, and heat loss of the smoke pan 31 is accordingly reduced. The gap also prevents the outer tube 10 from overheating, which would adversely affect the user's experience. The second sealing member 33 and the third sealing member 34 may be made of silicone or rubber, or other material not limited to the present disclosure.

To facilitate inhalations, the atomizer 100 of the present disclosure further includes a cigarette holder (not shown in figures). The cigarette holder is substantially a hollow tubular structure with openings at both ends. The cigarette holder is positioned at the upper end of the outer tube 10 and communicates with the atomizing cavity 311.

In the illustrated embodiment, the outer tube 10 is made of heat-insulating materials. Thus heat in the air inlet channel 212 and the smoke pan 31 is retained and not easily dissipated, and burning or scalding of the user's hand due to a high temperature of the outer tube 10 is avoided. The heat-insulating materials may include any one of mica, high temperature resistant silicone, high temperature resistant rubber, and polyether ketone (PEK).

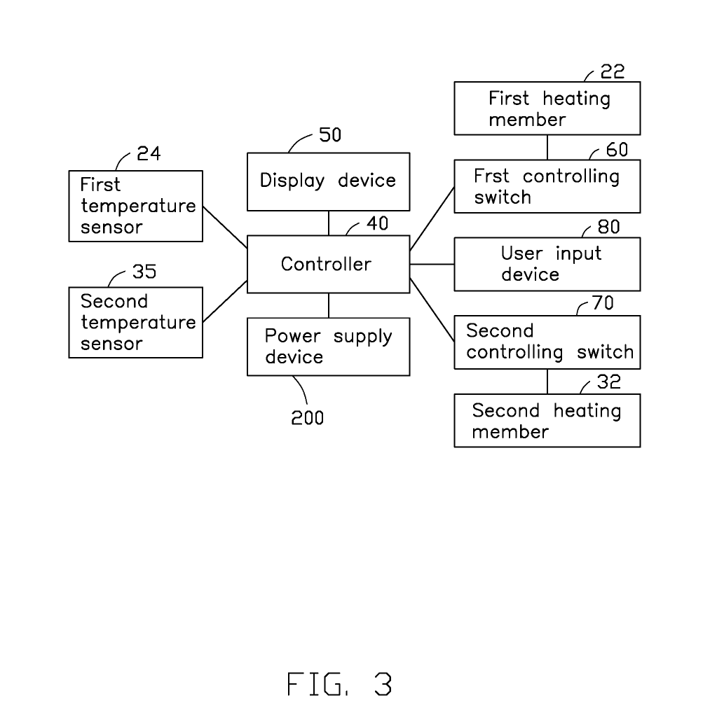

Referring to FIG. 3, the electronic cigarette of the present disclosure further includes a first temperature sensor 21, a second temperature sensor 35, a controller 40 positioned in the electronic cigarette, and a display device 50 positioned at the outside of the electronic cigarette. The controller 40 is electrically connected with the power supply device 200, the first heating member 22, the second heating member 32, the first temperature sensor 24, the second temperature sensor 35, and the display device 50.

The first temperature sensor 24 is positioned on or adjacent to the first heating member 22. The first temperature sensor 24 is configured to detect a temperature of the first heating member 22, and give feedback to the controller 40. The second temperature sensor 35 is positioned on or adjacent to the second heating member 32. The second temperature sensor 35 is configured to detect a temperature of the second heating member 32, and give feedback to the controller 40. In the illustrated embodiment, since a temperature difference between the first heating member 22 and the air inlet channel 212 is small, the temperature of the first heating member 22 is also taken as the temperature in the air inlet channel 212. Similarly, since a temperature difference between the second heating member 32 and the atomizing cavity 311 is small, the temperature of the second heating member 32 is also taken as the temperature in the atomizing cavity 311.

The temperature values detected by the first temperature sensor 24 and the second temperature sensor 35 are displayed to the user through the display device 50, to make the user aware of the temperatures in the air inlet channel 212 and the atomizing cavity 311. First and second preset values are provided in the controller 40. The first preset value may represent a desired temperature of the air inlet channel 212, which can be manually input by the user, or can be a recommended temperature of the air inlet channel 212 provided by the manufacturer. The second preset value may represent a desired temperature of the atomizing cavity 311, which can be manually input by the user, or can be a recommended temperature of the atomizing cavity 311 provided by the manufacturer. The first preset value and the second preset value can also be displayed to the user through the display device 50.

The controller 40 is able to compare the temperature fed back by the first temperature sensor 24 with the first preset value, and compare the temperature fed back by the second temperature sensor 34 with the second preset value. The power provided to the first heating member 22 and the second heating member 34 by the power supply device 200 can be adjusted by the controller 40 according to the result of comparison, so that the temperature in the air inlet channel 212 reaches the first preset value, and the temperature in the atomizing cavity 311 reaches the second preset value.

In another embodiment, when the temperature of the first heating member 22 is greatly different from the temperature in the air inlet channel 212, the temperature sensed by the first temperature sensor 24 is not used to indicate the temperature in the air inlet channel 212. Such temperature value indicating the temperature in the air inlet channel 212 can be obtained by adding the value detected by the first temperature sensor 24 with a first temperature compensation, and then be fed back to the controller 40. Similarly, when the temperature of the second heating member 32 is greatly different from the temperature in the atomizing cavity 311, the temperature value sensed by the second temperature sensor 35 is not used to indicate the temperature in the atomizing cavity 311. Such temperature value indicating the temperature in the atomizing cavity 311 can be obtained by adding the temperature value detected by the second temperature sensor 35 with a second temperature compensation, and then be fed back to the controller 40. The first temperature compensation and the second temperature compensation can be obtained by experiment and theoretical calculation. In the illustrated embodiment, the first preset value is equal to the second preset value, so that the temperatures in the air inlet channel 212 and the atomizing cavity 311 are or can be made the same. Therefore, the temperature of the gas flowing into the atomizing cavity 311 through the air inlet channel 212 can be same as the temperature in the atomizing cavity 311, avoiding excessive heat loss of the smoking materials due to lower temperature of the external gas.

In another embodiment, the first preset value can be smaller than the second preset value. The temperature in the air inlet channel 212 is controlled to be lower than the temperature in the atomizing cavity 311, so that the temperature of the gas flowing into the atomizing cavity 311 is lower than a temperature of the smoke. Therefore, the temperature of the smoke is reduced to prevent smoke which is too hot entering the user's mouth.

In another embodiment, the first preset value can be greater than the second preset value. The temperature in the air inlet channel 212 is controlled to be higher than the temperature in the atomizing cavity 311, so that the temperature of the gas flowing into the atomizing cavity 311 is higher than the temperature of the smoke. When the gas flows through the smoking materials, the gas heats the smoking material, which is advantageous in relation to smoking material that is not in contact with the wall of the smoke pan 31.

Therefore, the two heating members and two temperature sensors can control heating conditions of the smoke materials and the external air, thus to meet the diversified needs of users. Additionally, considering that different heating materials to be heated (smoking material and airflow are different materials to be heated) have different heating rates, the requirements for heating materials are also different. Therefore, the two heating members can facilitate the adjusting of heating power, and be convenient for the selection of applicable heating materials.

In the illustrated embodiment, the electronic cigarette further includes a first control switch 60 configured to control the first heating member 22, and a second control switch 70 configured to control the second heating member 32. The first control switch 60 is electrically connected with the controller 40 and the first heating member 22. The second control switch 70 is electrically connected with the controller 40 and the second heating member 32. With the first control switch 60 and the second control switch 70, the user is able to activate and deactivate the first heating member 22 and the second heating member 32 according to his/her actual needs. That is, the electrical connection between the first heating member 22 and the power supply device 200 can be turned on/off by first control switch 60. The electrical connection between the second heating member 32 and the power supply device 200 can be turned on/off by the second control switch 70. For example, the user can turn on the first heating member 22 for a certain time by switching on the first control switch 60, to preheat the air inlet channel 212. When the user needs to inhale, the second heating member 32 can be turned on by switching on the second control switch 70. Because of the preheating, the gas entering the atomizing cavity 311 already has a higher temperature, which can reduce the heat loss in the atomizing cavity 311. The hot gas assists in heating the smoking material, so that more smoke can be generated.

The first control switch 60 controls the work of the first temperature sensor 24, and the second control switch 70 controls the work of the second temperature sensor 35. Taking the first temperature sensor 24 as an example, when the controller 40 detects that the first control switch 60 is switched on, the first temperature sensor 24 is controlled to work by the controller 40. The first temperature sensor 24 detects the temperature of the first heating member 22 and gives feedback to the controller 40. The controller 40 compares the temperature detected by the first temperature sensor 24 with the first preset value, and the power provided to the first heating member 22 by the power supply device 200 is adjusted according to the comparison, so that the temperature in the atomizing cavity 311 can reach the first preset value. When the controller 40 detects that the first control switch 60 is switched off, the controller 40 controls the first temperature sensor 24 to stop working.

In the illustrated embodiment, the electronic cigarette further includes a user input device 80. The user input device 80 is electrically connected with the controller 40. For example, the user can input the first preset value and the second preset value through the user input device 80.

The user can select operating parameters of the first heating member 21 and the second heating member 32 in a heating mode and in a hold mode through the user input device 80. The operating parameters may include but are not limited to the first preset value, the second preset value, and holding times of the first heating member 21 and the second heating member 32. In the heating mode, the first heating member 21 is gradually heated up until the temperature of the first heating member 21 reaches the first preset value, and the second heating member 32 is gradually heated up until the temperature of the second heating member 32 reaches the second preset value. In the hold mode, the user can select the holding time of the first heating member 21 and the second heating member 32. After the temperature of the first heating member 21 reaches the first preset value, the working time for maintaining the temperature of the first heating member 21 at the first preset value is the holding time of the first heating member 21. After the temperature of the second heating member 32 reaches the second preset value, the working time for maintaining the temperature of the second heating member 32 at the second preset value is the holding time of the second heating member 32.

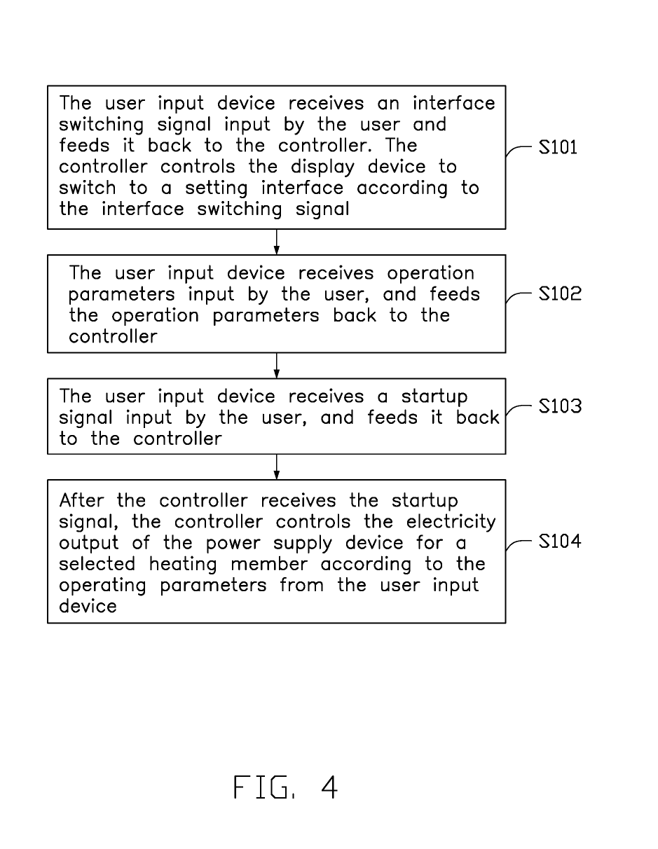

Referring to FIG. 4, working processes of the electronic cigarette may be as follows.

In step S101, the user input device 80 receives an interface switching signal input by the user and feeds it back to the controller 40. The controller 40 controls the display device 50 to switch to a setting interface according to the interface switching signal, and then the process continues to step S102. For example, in an embodiment, the user input device 80 includes parameter adjusting buttons. The parameter adjusting buttons include a power button, a “+” button, and a “−” button. The user gives three presses on the power button to produce the interface switching signal to enter the setting interface.

In step S102, the user input device 80 receives operation parameters input by the user, and feeds the input operation parameters back to the controller 40. Then, the process continues to step S103. For example, in an embodiment, the user can select an operating parameter to be adjusted through the “+” button, and press the “−” button to confirm the operating parameter. Then, the user can press the “+” button or the “−” button to adjust a value of the operating parameter. Finally, the user waits for 2 seconds or can give three presses on the power button to confirm the value of the operating parameter. In another manner, the operating parameter is selected by pressing the “+” button and the “−” button, and such input is confirmed by pressing the power button. The value of the selected operation parameter is adjusted by pressing the “+” button and the “−” button.

The operating parameter being adjusted in step S102 can be an operating temperature of a target heating member, or a holding time of the target heating member. The target heating member can be the first heating member 21, the second heating member 32, or both.

In step S103, the user input device 80 receives a startup signal input by the user, and feeds it back to the controller 40. Then, the process continues to step S104. For example, the user can press the power button for 3 seconds to activate the electronic cigarette.

In step S104, after the controller 40 receives the startup signal, the controller 40 controls the output of the power supply device 200 to the selected heating member according to the operating parameters from the user input device 80. In the illustrated embodiment, the controller 40 controls a heating power and a holding time of the power supply device 200 to the selected heating member according to the operating parameters.

If a holding time of a target heating member has been preset in step 102 as the operating parameter, then when the controller 40 is in the hold mode, the controller 40 controls the target heating member to work or not to work according to the holding time. For example, when the holding time has passed, the target heating member is powered off to stop heating the target heating member. Conversely, during the holding time, the target heating member can be heated at a holding power.

The user can select the target heating member by turning on/off the first control switch 60 and the second control switch 70. When the first control switch 60 is turned on, and the second control switch 70 is turned off, the target heating member can only be the first heating member 21. When the first control switch 60 is turned off, and the second control switch 70 is turned on, the target heating member can only be the second heating member 32. When both the first control switch 60 and the second control switch 70 are turned on, the first heating member 21 and the second heating member 32 are both selected to be target heating members.

The first control switch 60 and the second control switch 70 can be physical buttons or virtual switches. When the first control switch 60 and the second control switch 70 are physical buttons, the user can turn on/off the first control switch 60 and the second control switch 70 by pressing the buttons.

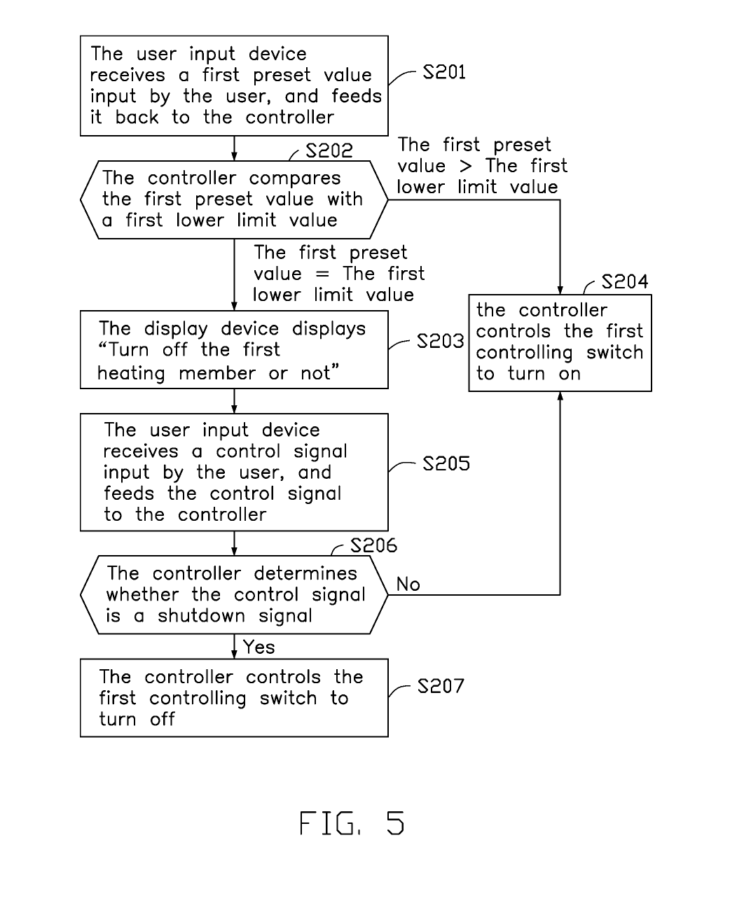

When the first control switch 60 and the second control switch 70 are virtual switches, they can be controlled as follows. Referring to FIG. 5, the control method of the first heating member 21 is taken as an example.

In step S201, the user input device 80 receives a first preset value input by the user, and gives feedback to the controller 40. Then, the process continues to step S202. The display device 50 is controlled to switch to a setting interface and the first preset value is provided by the methods shown in step S101 and step S102. The preset value may include an operating temperature and other operating parameters.

The first preset value or the second preset value input by the user can be set through buttons or can be set through a touch screen. Therefore, the step S201 can include:

The controller 40 receives the first preset value and/or the second preset value from the adjustment buttons. The adjustment buttons can be the “+” button or the “−” button. In actual use, when the preset value is lower than a lower limit value, for example when the electronic cigarette receives “−” instructions beyond the lower limit value, the electronic cigarette does not respond to such operations. Therefore, the preset value input by the user has to be not lower than the lower limit value.

Alternatively, the controller 40 receives a value as a preset from the touch screen. In actual use, the user can directly input a preset value through the touch screen in the displayed interface.

In step S202, the controller 40 compares the first preset value with a first lower limit value. When the first preset value is less than or equal to the first lower limit value, continue to step S203. When the first preset value is greater than the first lower limit value, continue to step S204. The first lower limit value is pre-stored in the controller 40. The first lower limit value refers to a smallest possible value of the first preset value that the user can set through the user input device 80. For example, the first lower limit value may be 200° C.; when setting the first preset value, the user can only set the first preset value as 200° C. or more. In this way, the temperature in the air inlet channel 212 will not be too low in the hold mode, so that the air flow does not act to cool and remove too much heat of the smoking material.

As for the second heating member 32, a second lower limit value is pre-stored in the controller 40. The second lower limit value refers to a smallest possible value of the second preset value that the user can set through the user input device 80. For example, in an embodiment, the second lower limit value may be 200° C.; when setting the second preset value, the user can only set the second preset value as 200° C. or more. In this way, the temperature in the atomizing cavity 311 will not be too low in the hold mode, to ensure the smoking material can be readily heated to generate smoke.

In other words, the user can set preset values for one or both of the first heating member 21 and the second heating member 32, and the electronic cigarette also stores lower limit values. The first lower limit value and the second lower limit value can be the lowest temperature at which smoking materials can be atomized to generate smoke.

In step S203, the display device 50 can display “Turn off first heating member?” as a first inquiry information. Then, the process continues to step S205. In another embodiment, such enquiry information can be transmitted to the user by other means, such as by lights, vibration, and audible voice.

In step S204, the controller 40 controls the first control switch 60 to turn on.

In step S205, the user input device 80 receives a control signal input by the user, and feeds the control signal to the controller 40. Then, the process continues to step S206. For example, in an embodiment, the user inputs the control signal through the “+” button and the “−” button. Pressing the “+” button can confirm that the first heating member 21 should be switched off. Pressing the “−” button can confirm that the first heating member 21 should not be switched off. Therefore, the control signal can be command information for continuing or stopping the heating of the first heating member 21.

In step S206, the controller 40 can determine whether the control signal is a shutdown signal. If the control signal is not the shutdown signal, the process continues to step S204. If the control signal is the shutdown signal, the process continues to step S207.

Preferably, steps S203, S205, and S206 are optional steps. In actual use, the steps S203, S205, and S206 may or may not be executed. When the first preset value is less than the first lower limit value, the step S207 can be executed directly.

In step S207, the controller 40 controls the first control switch 60 to turn off.

A method for control the second heating member 32 can refer to the control method of the first heating member 21, which is described above.

The above examples describe the setting of lower limit values. In actual implementation, problems may occur when the operating parameters are too high. For example, when the operating temperature of the heating member is too high, tobacco may be burnt, thereby resulting in a poor user experience. Therefore, upper limit values can also be set.

The first heating member 21 is taken as an example. A first upper limit value allowed by the first heating member 21 may be provided in advance. When the controller 40 receives the first preset value, the controller 40 compares the first preset value with the first upper limit value, and then controls the first heating member 21 to work or not. For example, in an embodiment, when the first preset value is greater than the first upper limit value, for the safety of the electronic cigarette, the first heating member 21 may be controlled not to heat beyond the first upper limit value. The electronic cigarette can also enquire “Turn off the first heating member?” as a second inquiry. When the controller 40 receives a confirmation of closing, the first heating member 21 is controlled not to heat. The control method of the second heating element 32 according to the upper limit value is similar to the example described above, thus the method is not explained again.

The atomizer 100 of the present disclosure can preheat the gas that enters the atomizing cavity 311 via the air inlet channel 212. Loss of heat of the smoking material is reduced, so more smoke is generated.

The electronic cigarette of the present disclosure has all the technical features of the atomizer 100 described above, so that the electronic cigarette has the same technical effects as the atomizer 100 described above. In the electronic cigarette of the present disclosure, the working conditions, operating temperatures, and operating modes of the first heating member 21 and the second heating member 32 can be selected and adjusted by the user according to his/her actual needs.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An atomizer, comprising:
an outer tube;
a ventilation assembly received in the outer tube; and
a smoke pan assembly received in the outer tube;
wherein the ventilation assembly is spaced from the smoke pan assembly, an air inlet channel is formed in the ventilation assembly, the ventilation assembly comprises a first heating member configured to heat the air inlet channel, the smoke pan assembly comprises a smoke pan and a second heating member configured to heat the smoke pan, and an atomizing cavity communicating with the air inlet channel is defined in the smoke pan.

2. The atomizer as claimed in claim 1, wherein the air inlet channel is formed by a space between the outer circumference surface of the first heating member and the inner circumference surface of the outer tube.

3. The atomizer as claimed in claim 1, wherein the ventilation assembly further comprises a ventilation member sleeved on the external of the first heating member, and the outer circumference surface of the ventilation member abuts against the inner circumference surface of the outer tube,
the ventilation member is a porous member, and the air inlet channel is formed by intercommunicating pores in the porous member.

4. The atomizer as claimed in claim 1, wherein the ventilation assembly further comprises a ventilation member sleeved on the external of the first heating member,
a spiral slice is formed on the outer circumference surface of the ventilation member, a side of the spiral slice away from the outer circumference surface of the ventilation member abuts against the inner circumference surface of the outer tube, or
a spiral slice is formed on the inner circumference surface of the outer tube, a side of the spiral slice away from the inner circumference surface of the outer tube abuts against the outer circumference surface of the ventilation member,
the air inlet channel is formed by a space between the outer circumference surface of the ventilation member, inner circumference surface of the outer tube, and the spiral slice.

5. The atomizer as claimed in claim 3, wherein a first flange is formed at an end of the ventilation member away from the smoke pan, a second flange is formed at another end of the ventilation member opposite to the first flange,
at least one first air inlet is defined on the first flange and/or the outer tube, the at least one first air inlet communicates with the air inlet channel,
at least one second air inlet is defined on the second flange, the at least one second air inlet communicates with the air inlet channel and the atomizing cavity.

6. The atomizer as claimed in claim 1, wherein the second heating member is positioned on the outer circumference surface of the smoke pan, or
the second heating member is positioned in the wall of the smoke pan, or
the second heating member is positioned on the inner circumference surface of the smoke pan, or
the second heating member is positioned in the inner cavity of the smoke pan.

7. The atomizer as claimed in claim 1, wherein a part of the inner circumferential surface of the outer tube 10 is extended inwardly along the radial direction of the outer tube to form a first supporting rim,
an end of the outer tube away from the ventilation assembly is bended inwardly along the radial direction of the outer tube to form a second supporting rim,
an end of the smoke pan abuts against the first supporting rim, another end of the smoke pan abuts against the second supporting rim.

8. The atomizer as claimed in claim 7, wherein a second sealing member is positioned between the first supporting rim and an end of the smoke pan adjacent to the ventilation assembly,
a third sealing member is positioned between the second supporting rim and another end of the smoke pan opposite to the second sealing member,
a gap is presented between the outer tube and the smoke pan with the existing of the second sealing member and the third sealing member.

9. An electronic cigarette, comprising an atomizer, wherein the atomizer comprises:
an outer tube,
a ventilation assembly received in the outer tube, and
a smoke pan assembly received in the outer tube,
wherein the ventilation assembly is spaced from the smoke pan assembly, an air inlet channel is formed in the ventilation assembly,
the ventilation assembly comprises a first heating member configured to heat the air inlet channel,
the smoke pan assembly comprises a smoke pan and a second heating member configured to heat the smoke pan,
an atomizing cavity communicating with the air inlet channel is defined in the smoke pan.

10. The electronic cigarette as claimed in claim 9, wherein the electronic cigarette further comprises a first temperature sensor, a second temperature sensor, a controller, and a power supply device,
the first temperature sensor is positioned on or adjacent to the first heating member,
the second temperature sensor is positioned on or adjacent to the second heating member,
the controller is electrically connected with the power supply device, the first heating member, the second heating member, the first temperature sensor, and the second temperature sensor.

11. A control method of an electronic cigarette, comprising following steps:
receiving a preset value for a target heating member, wherein the target heating member is a first heating member and/or a second heating member, the first heating member is configured to heat an air inlet channel of the electronic cigarette, the second heating member is configured to heat a smoke pan of the electronic cigarette;
controlling the target heating member to heat or not according to a relationship between the preset value and a corresponding limit value.

12. The control method as claimed in claim 11, wherein, if the corresponding limit value is a lower limit value, the step of controlling the target heating member to heat or not comprises:
when the preset value is less than or equal to the lower limit value, the target heating member is controlled not to heat.

13. The control method as claimed in claim 11, wherein, if the limit value is a lower limit value, the step of controlling the target heating member to heat or not comprises:
when the preset value is less than or equal to the lower limit value, the electronic cigarette displays a first inquiry information, the first inquiry information is configured to inquire whether the target heating member is controlled to head or not;
if a confirmation message for confirming to heat the target heating member is received, the target heating member is controlled to heat;
if a confirmation message for confirming not to heat the target heating member is received, the target heating member is not controlled to heat.

14. The control method as claimed in claim 11, wherein, if the limit value is an upper limit value, the step of controlling the target heating member to heat or not comprises:
if the preset value is greater than the upper limit value, the target heating member is not controlled to heat.

15. The control method as claimed in claim 14, wherein, if the limit value is an upper limit value, the step of controlling the target heating member to heat or not comprises:
the electronic cigarette displaying a second inquiry information when the preset value is greater than the upper limit value, wherein the second inquiry information is configured to inquire whether the target heating member is controlled to head or not;
if a confirmation message for confirming to heat the target heating member is received, the target heating member is controlled to heat;
if a confirmation message for confirming not to heat the target heating member is received, the target heating member is not controlled to heat.

16. The control method as claimed in claim 11, wherein the step of receiving the preset value for the target heating member comprises:
receiving the preset value set by parameter adjusting buttons; or
receiving the preset value input through a touch screen.

17. The control method as claimed in claim 11, wherein the control method further comprises steps of:
receiving an interface switching signal configured to switch a display interface of a display device of the electronic cigarette into a setting interface;
displaying the setting interface according to the interface switching signal;
receiving the preset value through the setting interface.

18. The control method as claimed in claim 11, wherein the control method further comprises steps of:
receiving a holding time set for the target heating member;
when the electronic cigarette is in a hold mode, the target heating member is controlled to heat or not according to the holding time.
